(19) United States
(12) Patent Application Publication
(10) Pub. No.: US 2013/0195433 A1
(43) Pub. Date: Aug. 1, 2013

(54) LIQUID-HEATING BOILER

(71) Applicant: Alessandro Magno, Brembate Sopra (IT)

(72) Inventor: Alessandro Magno, Brembate Sopra (IT)

(73) Assignee: N&W GLOBAL VENDING S.P.A., Valbrembo (IT)

(21) Appl. No.: 13/641,357

(22) PCT Filed: Apr. 27, 2011
(86) PCT No.: PCT/IB11/00908

§ 371 Date: Dec. 7, 2012

(30) Foreign Application Priority Data
Apr. 27, 2010 (IT) TO2010A000351

(51) Int. Cl. F24H 9/14; F24H 1/10

(52) U.S. Cl. CPC F24H 9/144; F24H 1/102; B67D 7/82
USPC 392/488; 392/311

(57) ABSTRACT

A boiler for heating a liquid, in particular water, and having at least one module in turn having a cylindrical conduit closed at the ends by two caps and fitted through with an electric resistor, which defines an annular channel between itself and the conduit, and is fitted in fluidtight manner to each cap and to the inner surface of the conduit by a respective single seal; the conduit having a tubular inlet fitting and tubular outlet fitting, which are located close to the opposite axial ends of the annular channel, are independent of the caps, and have respective channels extending radially with respect to and communicating with the annular channel; the tubular inlet and outlet fittings being complementary in shape.

### TECHNICAL FIELD

The present invention relates to a boiler for heating a liquid, in particular water.

More specifically, the present invention relates to a boiler of the type comprising at least one module, in turn comprising a conduit having two open opposite axial ends; two removable caps for closing respective axial ends, and each having a central through hole; an electric resistor fitted through the central through holes in the caps, and extending the full length of the conduit to define, between itself and the conduit, an annular-section channel of the same length as the conduit; and a tubular inlet fitting and tubular outlet fitting, which communicate with the annular-section channel, are complementary in shape, and located close to the opposite axial ends of the annular-section channel.

### BACKGROUND ART

Boilers of this sort are described, for example, in DE-196 13 579, DE-20 2004 009 349 U1, EP-1 316 762 and, in particular, EP-1 653 163.

The present invention is particularly advantageous for use in applications requiring repeat supply of a given amount of liquid, normally water, at a relatively high temperature, and in particular in hot-beverage vending machines, to which the following description refers purely by way of example.

Hot-beverage vending machines need boilers of the above type which are not only capable of producing hot water in varying amounts and at different temperatures, depending on the beverages selected, but can also be opened and inspected easily for fast, easy maintenance and cleaning, as required when the hot water, as in the case of vending machines, is meant for consumption.

In known boilers of the above type, the inlet and outlet fittings are normally fitted to the caps.

This makes the fittings easier to orient when installing multiple-module boilers, but has the drawback that any maintenance or cleaning work, for which the caps must be removed, necessarily calls for dismantling the whole boiler.

Moreover, because the electric resistors of known boilers of the above type are through-fitted, for safety reasons, with their terminals outside the boiler body, each end of each module requires two different sealing systems—one between the cap and the resistor, and the other, which is particularly complex, between the cap and the conduit—both of which must be removed completely for access to the inside of the boiler.

### DISCLOSURE OF INVENTION

It is an object of the present invention to provide a boiler, preferably a modular boiler, designed to eliminate the above drawbacks and enable fast, easy maintenance and cleaning.

According to the present invention, there is provided a liquid-heating boiler as claimed in claim 1 and preferably in any one of the following Claims depending directly or indirectly on claim 1.

### BRIEF DESCRIPTION OF THE DRAWINGS

A non-limiting embodiment of the invention will be described by way of example with reference to the accompanying drawings, in which :

FIG. 1 shows an exploded view in perspective of a preferred embodiment of the boiler according to the present invention;

FIG. 2 shows a plan view of the FIG. 1 boiler;

FIG. 3 shows a section along line in FIG. 2;

FIG. 4 shows a section along line IV-IV in FIG. 3;

FIG. 5 shows a larger-scale axial section of a detail of a variation of the FIG. 1 boiler.

### BEST MODE FOR CARRYING OUT THE INVENTION

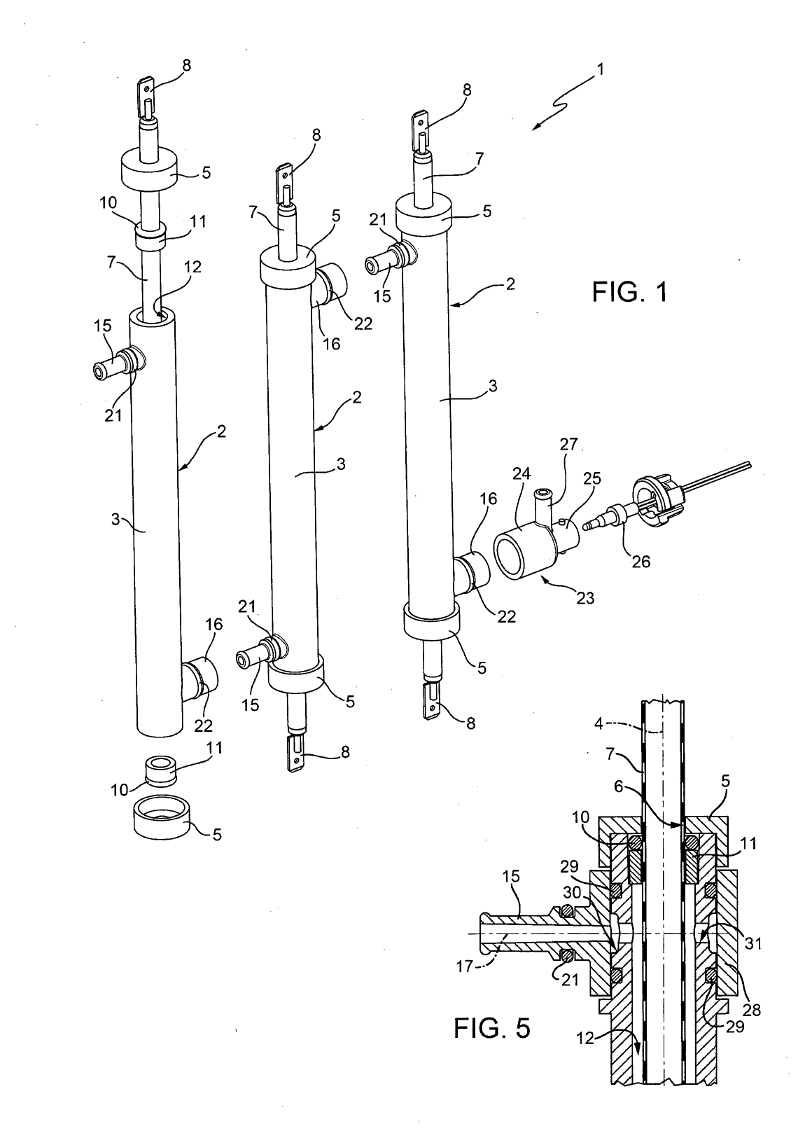

Number 1 in FIG. 1 indicates as a whole a boiler for instantaneously heating water and/or producing steam.

Boiler 1 is a modular boiler defined by one or more identical, releasably series-connected modules 2.

As shown more clearly in FIG. 3, each module 2 comprises a cylindrical conduit 3 having an axis 4 and closed at each end by a pressure or screw cap 5 having an axial hole 6 engaged in sliding manner by a shielded resistor 7.

Resistor 7 extends the full length of conduit 3, has end portions projecting from conduit 3 and each fitted with an electric terminal 8, and is fitted to an inner surface 9 of conduit 3 with the interposition of two annular seals 10, each of which is fitted to shielded resistor 7, is located close to a respective cap 5, and is locked axially to cap 5 by a spacer 11, so that, when each cap 5 is fitted to the respective end of conduit 3, respective seal 10 deforms, thus locking resistor 7 in fluidtight manner to inner surface 9 of conduit 3 and to the inner surface of respective cap 5, at respective hole 6.

Inside conduit 3, resistor 7 defines an annular-section channel 12 divided into two axial portions by an annular rib 13 (FIG. 4), which projects inwards from inner surface 9 to contact the outer surface of resistor and lock resistor 7 transversely in position with respect to conduit 3, and has a number of radial cavities 14 connecting the two axial portions of channel 12.

Each module 2 comprises a tubular inlet fitting 15 and a tubular outlet fitting 16, each extending radially outwards from conduit 3, close to relative cap 5. More specifically, tubular inlet and outlet fittings 15, 16 have respective axes 17, 18, which intersect axis 4 and, when projected in a plane perpendicular to axis 4, form an angle of 180°, in the example shown, but which may range from 0° to 180°.

As shown in FIG. 3, tubular inlet and outlet fittings 15, 16 have different outside diameters, are complementary in shape, and have respective inner axial channels 19, 20 coaxial with respective axes 17, 18 and communicating with channel 12 through respective radial holes 19a, 20a formed through conduit 3.

One of the two tubular fittings—in the example shown, tubular inlet fitting 15—has an outside diameter slightly smaller than the inside diameter of the other tubular fitting—in the example shown, tubular outlet fitting 16—and has, on its outer surface, an annular groove engaged by an annular seal 21. Similarly, the other tubular fitting—in the example shown, tubular outlet fitting 16—has, on its outer surface, an annular groove engaged by an annular seal 22.

In a variation not shown, boiler 1 comprises one module 2, the tubular inlet fitting 15 of which is connectable to a water supply, and the tubular outlet fitting 16 of which is connectable to a user device.

In the FIG. 3 example, boiler 1 is formed by assembling two or more modules 2—in the example shown, three modules 2 indicated 2a, 2b, 2c, by inserting tubular inlet fitting 15 of module 2b in fluidtight manner inside tubular outlet fitting 16 of module 2a, and inserting tubular inlet fitting 15 of module 2c in fluidtight manner inside tubular outlet fitting 16 of module 2b. In boiler 1 so formed, tubular inlet fitting of module 2a forms the inlet, and tubular outlet fitting 16 of module 2c the outlet, of boiler 1.

The outlet of boiler 1 is preferably connected indirectly to a user device by a hydraulic joint 23 comprising a conduit, one end portion 24 of which fits in fluidtight manner onto the outlet of boiler 1, and another end portion 25 of which is engaged in fluidtight manner by a temperature-control probe 26. In an intermediate position between end portions 24 and 25, hydraulic joint 23 has a radial outlet fitting 27.

In actual use, the water for heating flows into boiler 1 through inlet fitting 15 of module 2a, and, as it flows along channels 12 of modules 2a, 2b, 2c to fitting 27 of hydraulic joint 23, is heated by respective resistors 7, the power of which is set according to the desired water temperature.

In connection with the above, it is important to note the high degree of versatility of boiler 1, which, by virtue of its modular design, is easily adaptable to different requirements in terms of both the amount of water to produce at a given temperature, and the final water temperature. That is, given the heating power of a module 2, boiler 1 can be ‘sized’ to a specific application by simply assembling the appropriate number of modules 2. For example, for a given final water temperature, boiler 1 can produce amounts of hot water in direct proportion to the number of modules 2 of which it is composed.

Resistors 7 are preferably activatable independently, to permit control of final water temperature for a given number of modules 2 of boiler 1.

Boiler 1 may be variously configured, depending on how modules 2 are assembled, for easier location of boiler 1 and more efficient use of the space inside the vending machine. In FIG. 3, for example, modules 2a, 2b, 2c are assembled with respective axes 4 coplanar, so boiler 1 extends widthwise. By simply rotating each tubular inlet fitting 15 with respect to the tubular outlet fitting 16 to which it is connected, a different configuration of boiler 1 can be obtained, e.g. in which boiler 1 extends lengthwise.

Other configurations of boiler 1, different from those obtainable from boiler 1 shown in the attached drawings, can be obtained, for example, using modules 2, in which axes 17 and 18 form an angle other than 180°. In which case, it is possible, for example, to obtain a substantially curved boiler 1.

A high degree of versatility, in terms of assembly, is obtainable using the FIG. 5 variation, in which one of the two tubular fittings—in the example shown, tubular inlet fitting 15—can be rotated about axis 4 to orient it with respect to and form a given angle with the other tubular fitting—in the example shown, tubular outlet fitting 16—depending on assembly requirements.

In FIG. 5, tubular inlet fitting 15 is integral with a sleeve 28 coaxial with axis 4 and fitted to conduit 3 in angularly free manner, with the interposition of two annular seals 29, to rotate with respect to conduit 3 about axis 4. Regardless of the angular position of sleeve 28 about axis 4, channel 19 of tubular inlet fitting 15 communicates with channel 12 via an annular chamber 30, which is defined by sleeve 28 and by an annular groove formed in the outer surface of conduit 3, and communicates with channel 12 via two or more radial holes 31 in conduit 3.

In variations not shown, tubular outlet fitting 16 or both tubular fittings may be orientable.

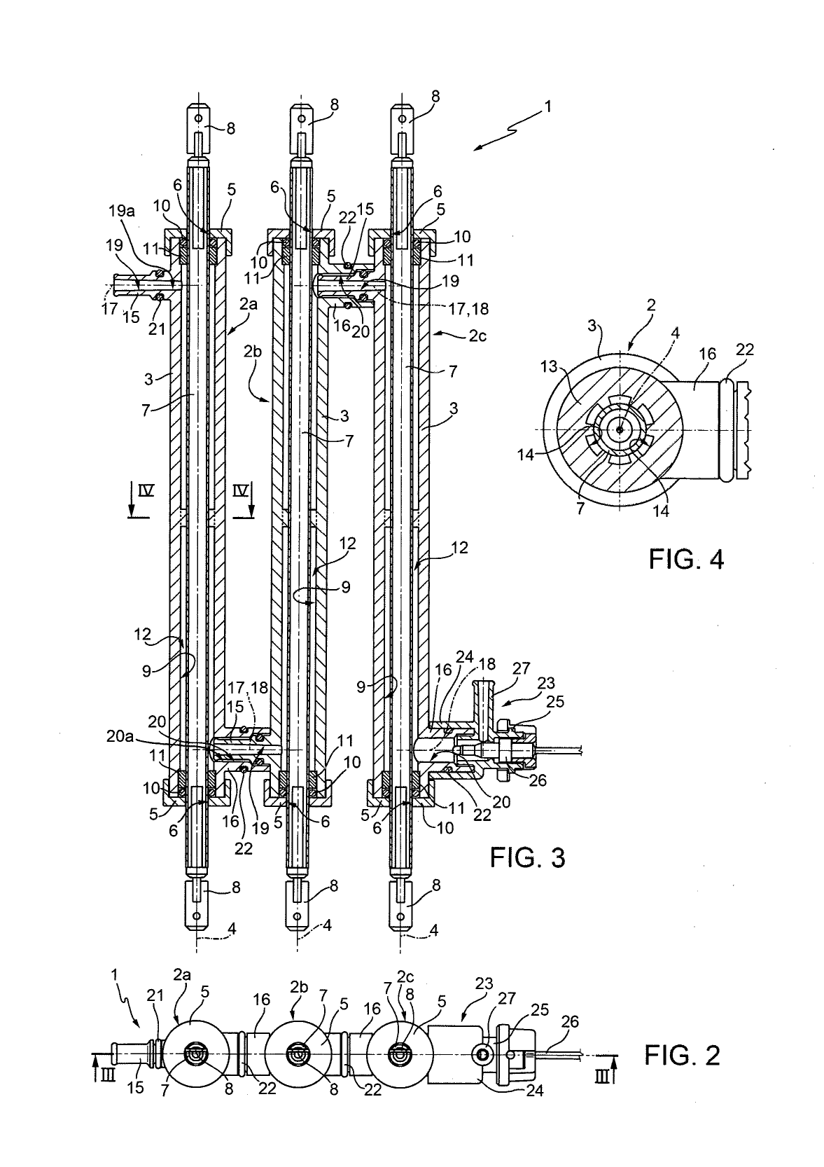

In both the FIG. 1-4 embodiment and FIG. 5 variation, tubular inlet and outlet fittings 15, 16 being independent of caps 5 enables removal of caps 5 without separating modules 2.

Moreover, the inside of conduit 3 can be inspected and accessed by simply moving caps 5 slightly from the closed position to relax seals 10 and so free resistors 7, which can thus be simply withdrawn through caps 5.

1. A boiler for heating a liquid comprising:
at least one module including:
a generally cylindrical conduit having two open opposite axial ends;
two removable caps for closing respective ones of the open opposite axial ends;
an electric resistor extending a full length of the generally cylindrical conduit to define, between the electric resistor and the generally cylindrical conduit, an annular-section channel of substantially the same length as the full length of the generally cylindrical conduit; and
a radial tubular inlet fitting and a radial tubular outlet fitting, which communicate with the annular-section channel, are located close to the open opposite axial ends of the annular-section channel, are separate from the two removable caps, are fitted directly to the generally cylindrical conduit, and communicate with the annular-section channel through respective radial holes formed through the generally cylindrical conduit;
wherein the radial tubular inlet fitting and radial tubular outlet fitting are complementary in shape;
wherein each of the two removable caps has a generally central through hole through which the respective electric resistor extends; and
sealing means are fitted to each of the open opposite axial ends of the generally cylindrical conduit, are compressed by the respective two removable caps in the closed position, and, when compressed, secure the electric resistor in fluidtight manner to an inner surface of the generally cylindrical conduit and to the two removable caps, at said-the generally central through holes.

2. The boiler as claimed in claim 1, wherein the radial tubular inlet and outlet fittings form a given angle of about 0 to about 180°.

3. The boiler as claimed in claim 1, wherein the radial tubular inlet and outlet fittings have different outside diameters; and one of the radial tubular inlet or outlet fittings has an outside diameter smaller than the inside diameter of the other one of the radial tubular inlet or outlet fittings.

4. The boiler as claimed in claim 3, wherein the radial tubular inlet or outlet fitting with the smaller outside diameter has, on an outer surface thereof, an annular groove engaged by an annular seal.

5. The boiler as claimed in claim 3, wherein the radial tubular inlet or outlet fitting with the smaller outside diameter is the radial tubular inlet fitting.

6. The boiler as claimed in claim 1, further comprising a hydraulic joint, which is connected to the radial tubular outlet fitting, has an outlet connecting the boiler to a user device, and is fitted with a temperature-control probe.

7. The boiler as claimed in claim 6, wherein the radial tubular outlet fitting has, on an outer surface thereof, an annular groove engaged by an annular seal for fluidtight connection to the hydraulic joint.

8. The boiler as claimed in claim 1, wherein the at least one module includes a number of modules; the radial tubular outlet fitting of each of the number of modules connected in fluidtight manner to the radial tubular inlet fitting of the next one of the number of modules.

9. The boiler as claimed in claim 8, wherein the electric resistors of the number of modules are electrically independent.

10. The boiler as claimed in claim 1, wherein the generally cylindrical conduit has a longitudinal axis; and at least one of the radial tubular inlet or outlet fittings is fitted to the generally cylindrical conduit n angularly free manner to rotate with respect to the generally cylindrical conduit about the axis.

11. A beverage vending machine comprising the boiler as claimed in claim 1.

12. A boiler for heating a liquid, comprising:
at least one module including:
a generally cylindrical conduit having two open opposite axial ends;
two removable caps configured to close respective ones of the open opposite axial ends;
an electric resistor extending a full length of the generally cylindrical conduit to define, between the electric resistor and the generally cylindrical conduit, an annular-section channel of substantially the same length as the full length of the generally cylindrical conduit; and
a radial tubular inlet fitting and a radial tubular outlet fitting complementary in shape, which:
communicate with the annular-section channel;
are located close to the open opposite axial ends of the annular-section channel are separate from the two removable caps;
are fitted directly to the generally cylindrical conduit; and
communicate with the annular-section channel through respective radial holes formed through the generally cylindrical conduit;
wherein each of the two removable caps has a generally central through hole through which the respective electric resistor extends; and
seals fitted to each of the open opposite axial ends of the generally cylindrical conduit that are compressed by the respective two removable caps in the closed position, and, when compressed, secure the electric resistor in fluidtight manner to an inner surface of the generally cylindrical conduit and to the two removable caps at the generally central through holes.
